(19) United States
(12) Patent Application Publication
(10) Pub. No.: US 2024/0351245 A1
(43) Pub. Date: Oct. 24, 2024

(54) PIPE SEGMENTS, NOZZLES, SYSTEMS AND METHODS FOR THERMOSET MANUFACTURING

(71) Applicant: The Boeing Company, Arlington, VA (US)

(72) Inventor: Jacquelynn X. Tian, Melbourne (AU)

(73) Assignee: The Boeing Company, Arlington, VA (US)

(21) Appl. No.: 18/305,538

(22) Filed: Apr. 24, 2023

(51) Int. Cl. B29B 7/32; B29B 7/82

(52) U.S. Cl. CPC B29B 7/325; B29B 7/826; B33Y 80/00

(57) ABSTRACT

A pipe segment for thermoset manufacturing includes a pipe body with an exterior surface, a main inlet portion, a main outlet portion, a secondary inlet portion and a secondary outlet portion. The pipe body defines a main chamber and a secondary chamber. A nozzle for thermoset manufacturing includes a nozzle body with an exterior surface, a main inlet portion, a main outlet portion, a secondary inlet portion and a secondary outlet portion. The nozzle body defines a main chamber and a secondary chamber. The main inlet portion includes at least two main inlet orifices. The main outlet portion includes a main outlet orifice. The secondary inlet portion includes a secondary inlet orifice. The secondary outlet portion includes a secondary outlet orifice. A system for thermoset manufacturing includes a pipe segment, a three-way valve and first, second and third fluid subsystems. A method for thermoset manufacturing is also provided.

### FIELD

The present disclosure relates generally to thermoset manufacturing and, particularly, to pipe segments, nozzles, systems and methods that circulate a heated fluid proximate to a mixing chamber that produces a mixed fluid for thermoset manufacturing. Various techniques are contemplated for circulating the heated fluid. Likewise, various mechanisms for influencing and controlling the transfer of heat to the mixing chamber are also contemplated.

### BACKGROUND

Manufacturers often purchase mixed resin from suppliers. The mixed resin is transported at low temperatures to production sites to ensure the resin does not progress beyond an acceptable level of cure, which would make the resin unusable or at least compromise its shelf life. A way to eliminate the cost and risk associated with the transport of mixed resin is mixing the resin at the production sites using static mixers. Static mixers use off-the shelf nozzles, which are normally made from plastic. The resin passes through the nozzle and is mixed. However, due to the large difference between the ambient temperature and the optimum temperature for resin mixing, insulating material is normally wrapped around the plastic nozzle to maintain the temperature for optimum resin mixing. The ambient temperature of the manufacturing environment changes from season to season, making it cumbersome to maintain the required temperature in this manner.

Accordingly, those skilled in the art continue with research and development efforts to improve techniques for inline resin mixing in conjunction with thermoset manufacturing, particularly improvement relating to inline resin mixing tools.

### SUMMARY

Disclosed are examples of pipe segments, nozzles, systems and methods for thermoset manufacturing. The following is a non-exhaustive list of examples, which may or may not be claimed, of the subject matter according to the present disclosure.

In an example, the disclosed pipe segment for thermoset manufacturing includes a pipe body with an exterior surface, a main inlet portion, a main outlet portion, a secondary inlet portion and a secondary outlet portion. The pipe body defines a main chamber that extends from the main inlet portion to the main outlet portion. The pipe body also defines a secondary chamber between the exterior surface and the main chamber that extends from the secondary inlet portion to the secondary outlet portion.

In an example, the disclosed nozzle for thermoset manufacturing includes a nozzle body with an exterior surface, at least two main inlet orifices, a main outlet orifice, a secondary inlet orifice and a secondary outlet orifice. The nozzle body defines a main chamber extending from the at least two main inlet orifices to the main outlet orifice. The nozzle body further defines a secondary chamber between the exterior surface and the main chamber and extending from the secondary inlet orifice to the secondary outlet orifice.

In an example, the disclosed system for thermoset manufacturing includes a pipe segment, a three-way valve, a first fluid subsystem, a second fluid subsystem and a third fluid subsystem. The pipe segment includes a pipe body with an exterior surface, a main inlet portion, a main outlet portion, a secondary inlet portion and a secondary outlet portion. The pipe body defines a main chamber that extends from the main inlet portion to the main outlet portion. The pipe body also defines a secondary chamber between the exterior surface and the main chamber that extends from the secondary inlet portion to the secondary outlet portion. The main inlet portion includes a main inlet orifice. The main outlet portion includes a main outlet orifice. The secondary inlet portion includes a secondary inlet orifice. The secondary outlet portion includes a secondary outlet orifice. The three-way valve includes a first inlet connection, a second inlet connection and an outlet connection. The three-way valve is in fluid communication with the main chamber of the pipe body via the outlet connection. The first fluid subsystem is in fluid communication with the three-way valve and the main chamber of the pipe body. The first fluid subsystem is configured to selectively supply a first mixing component to the main chamber via the first inlet connection, the outlet connection and the main inlet orifice. The second fluid subsystem is in fluid communication with the three-way valve and the main chamber of the pipe body. The second fluid subsystem is configured to selectively supply a second mixing component to the main chamber via the second inlet connection, the outlet connection and the main inlet orifice. The third fluid subsystem is in fluid communication with the secondary chamber of the pipe body. The third fluid subsystem is configured to selectively circulate a fluid through the secondary chamber via the secondary inlet orifice and the secondary outlet orifice.

In an example, the disclosed method for thermoset manufacturing includes: (1) receiving a first flow of a first mixing component from a first fluid subsystem; (2) receiving a second flow of a second mixing component from a second fluid subsystem; (3) receiving a fluid circulated by a third fluid subsystem; (4) mixing the first mixing component and the second mixing component to form a mixed fluid; and (5) maintaining a predetermined mixing temperature for the first mixing component and the second mixing component during the mixing.

Other examples of the disclosed pipe segments, nozzles, systems and methods for thermoset manufacturing will become apparent from the following detailed description, the accompanying drawings and the appended claims.

### BRIEF DESCRIPTION OF THE DRAWINGS

FIG. 1A is a side view of an example of a pipe segment for thermoset manufacturing,

FIG. 1B is a cross-sectional view of the pipe segment, FIG. 1C is a top view of the pipe segment,

FIG. 1D is a bottom view of the pipe segment;

FIG. 2A is a side view of an example of a nozzle for thermoset manufacturing, FIG. 2B is a cross-sectional view of the nozzle, FIG. 2C is a top view of the nozzle, FIG. 2D is a bottom view of the nozzle;

FIG. 3A is a side view of another example of a nozzle for thermoset manufacturing, FIG. 3B is a cross-sectional view of the nozzle, FIG. 3C is a top view of the nozzle, FIG. 3D is a bottom view of the nozzle;

FIG. 4 is an exploded isometric view of yet another example of a nozzle for thermoset manufacturing;

FIG. 5 is an exploded isometric view of still another example of a nozzle for thermoset manufacturing;

FIG. 6A is the top view of the nozzle of FIG. 3A, FIG. 6B is a partial cross-sectional drawing showing an internal unwrapped view of an example of a secondary chamber for the nozzle;

FIG. 7A is the side view of the nozzle of FIG. 2A, FIG. 7B is a partial cross-sectional drawing showing an internal unwrapped view of an example of a secondary chamber for the nozzle;

FIG. 8A is the top view of the nozzle of FIG. 3A, FIG. 8B is a partial cross-sectional drawing showing an internal unwrapped view of another example of a secondary chamber for the nozzle;

FIG. 9A is the side view of the nozzle of FIG. 2A, FIG. 9B is a partial cross-sectional drawing showing an internal unwrapped view of another example of a secondary chamber for the nozzle;

FIG. 10 is the cross-sectional view of the pipe segment of FIG. 1A with an example of a mixing element disposed within the main chamber of the pipe segment;

FIG. 11A is a side view of an example of a spiral mixing element;

FIG. 11B is a side view of an example of a helical mixing element;

FIG. 11C is a side view of an example of a stair step mixing element;

FIG. 12 is an exploded isometric view of another example of a pipe segment for thermoset manufacturing;

FIG. 13 is a functional block diagram of an example of a system for thermoset manufacturing;

FIG. 14 is a functional block diagram of an example of a first fluid subsystem that supplies a first mixing component in a system for thermoset manufacturing, the diagram also shows an example of a second fluid subsystem that supplies a second mixing component in the system;

FIG. 15 is a functional block diagram of an example of a third fluid subsystem that circulates a fluid through a secondary chamber in a system for thermoset manufacturing;

FIG. 16 is a flow diagram of an example of a method for thermoset manufacturing;

FIG. 17, in combination with FIG. 16, is a flow diagram of another example of a method for thermoset manufacturing;

FIG. 18 is a block diagram of aircraft production and service methodology; and

FIG. 19 is a schematic illustration of an aircraft.

### DETAILED DESCRIPTION

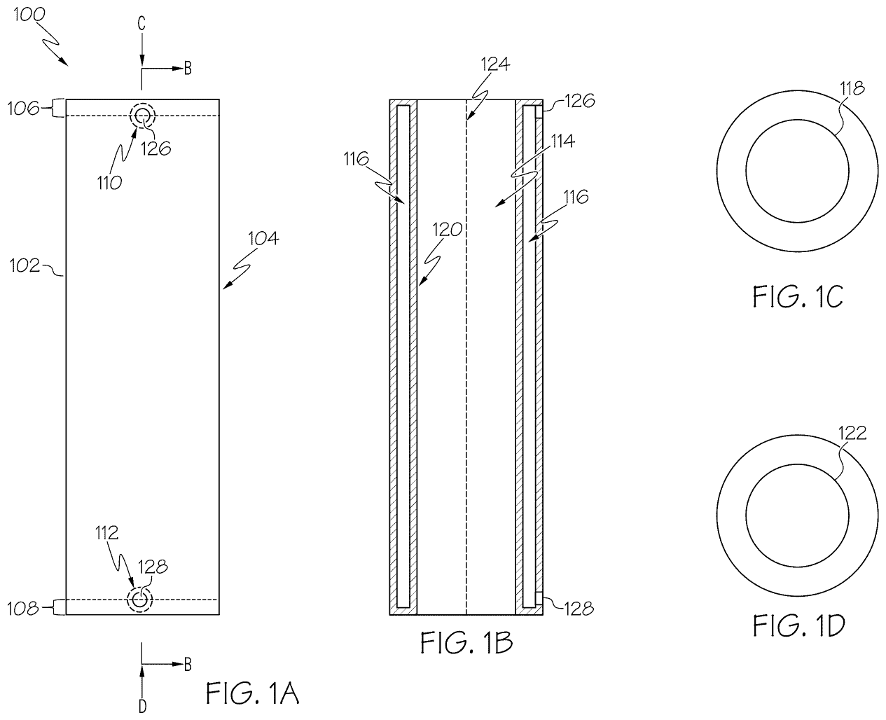

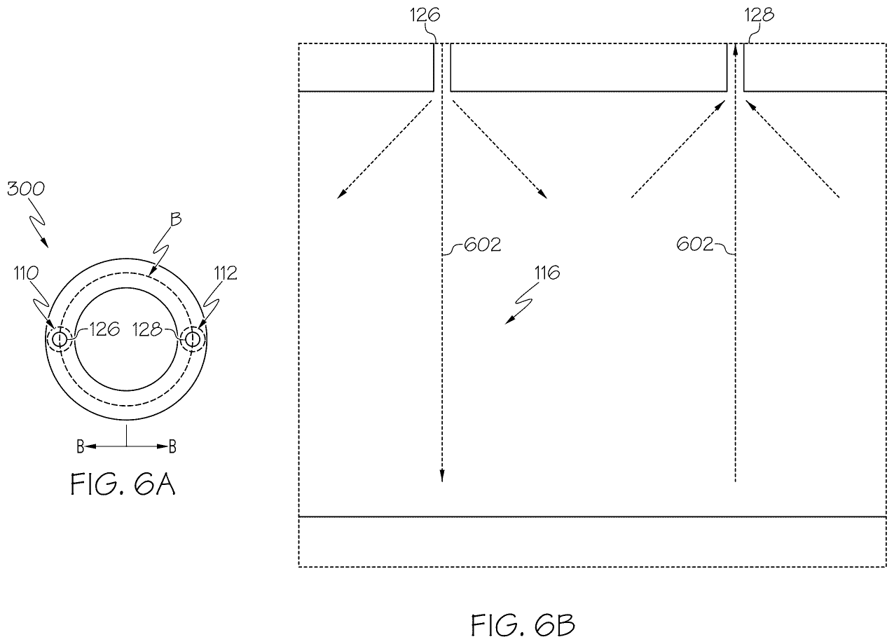

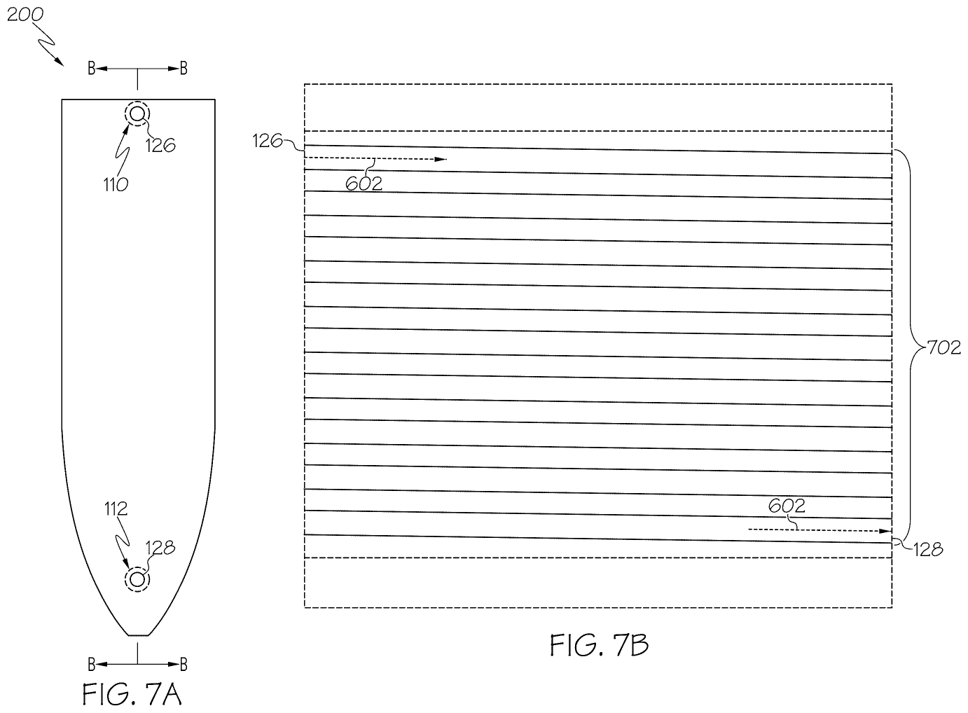

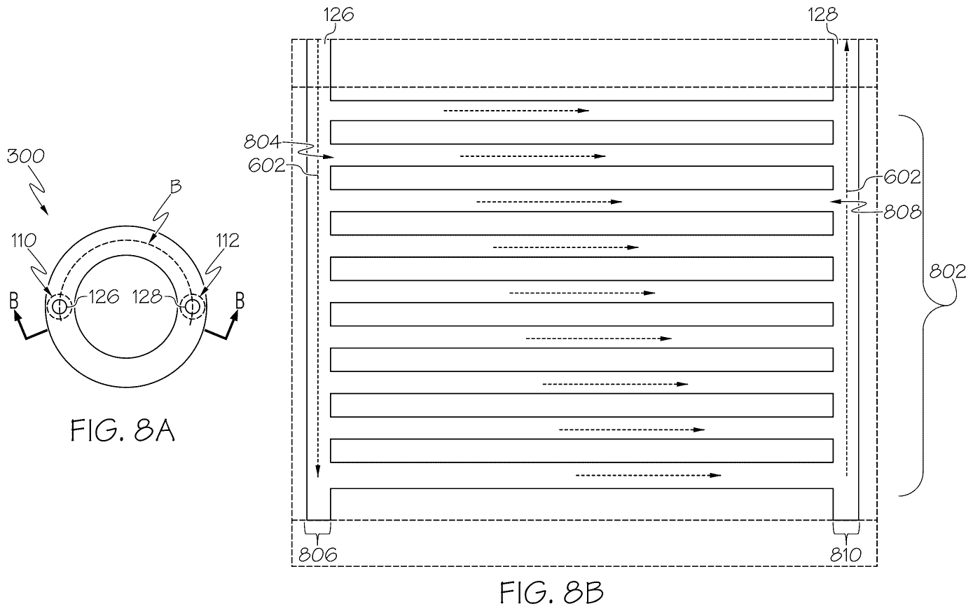

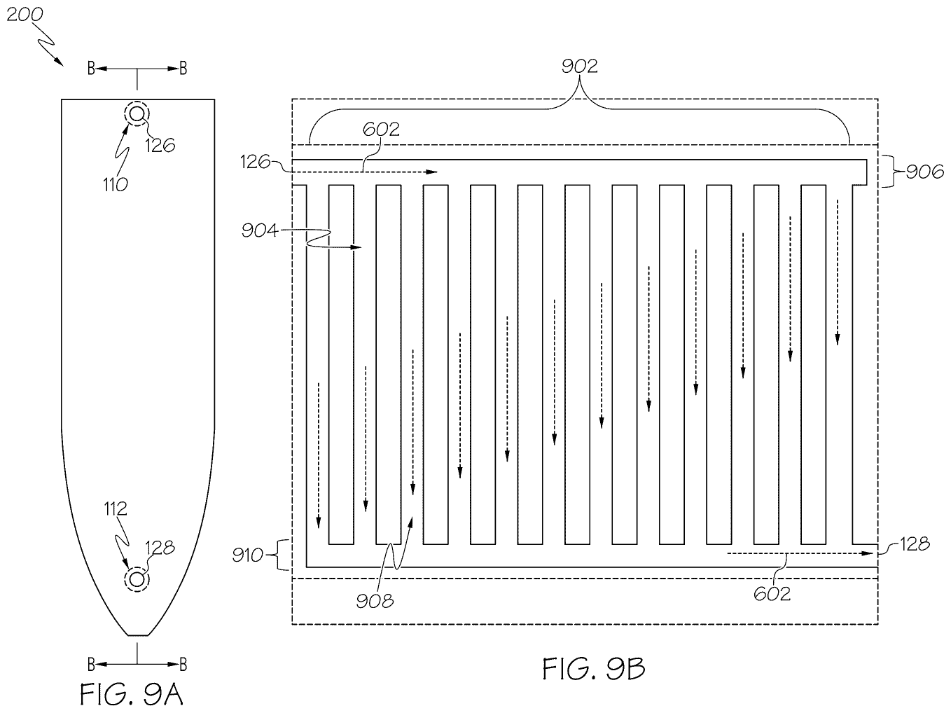

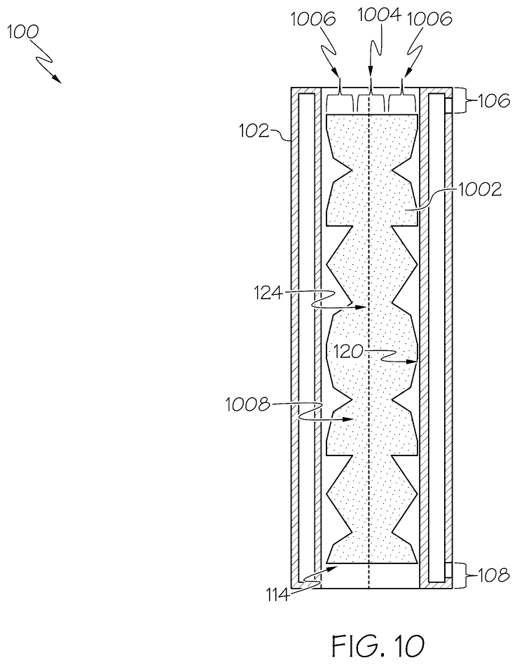

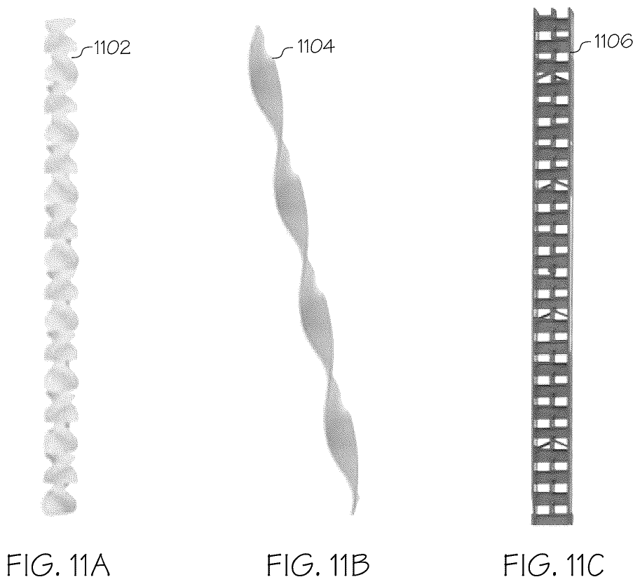

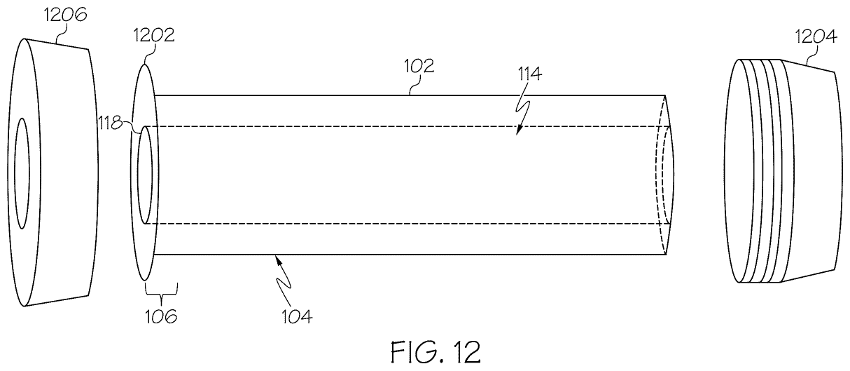

Referring generally to FIGS. 1A-D, 6A-B, 7A-B, 8A-B, 9A-B, 10, 11A-C and 12, by way of examples, the present disclosure is directed to a pipe segment 100 for thermoset manufacturing. FIGS. 1A-D, 10 and 12 disclose examples of the pipe segment 100 which includes a pipe body 102 that defines a main chamber 114 and a secondary chamber 116. FIGS. 6B, 7B, 8B and 9B disclose various examples of configurations for the secondary chamber 116. FIG. 10 discloses an example of the pipe segment 100 with a mixing element 1002. FIGS. 11A-C disclose examples of various types of mixing elements 1002. FIG. 12 discloses another example of the pipe segment 100 with a flange 1202 and retaining mechanism 1204 for coupling to a connector mechanism 1206.

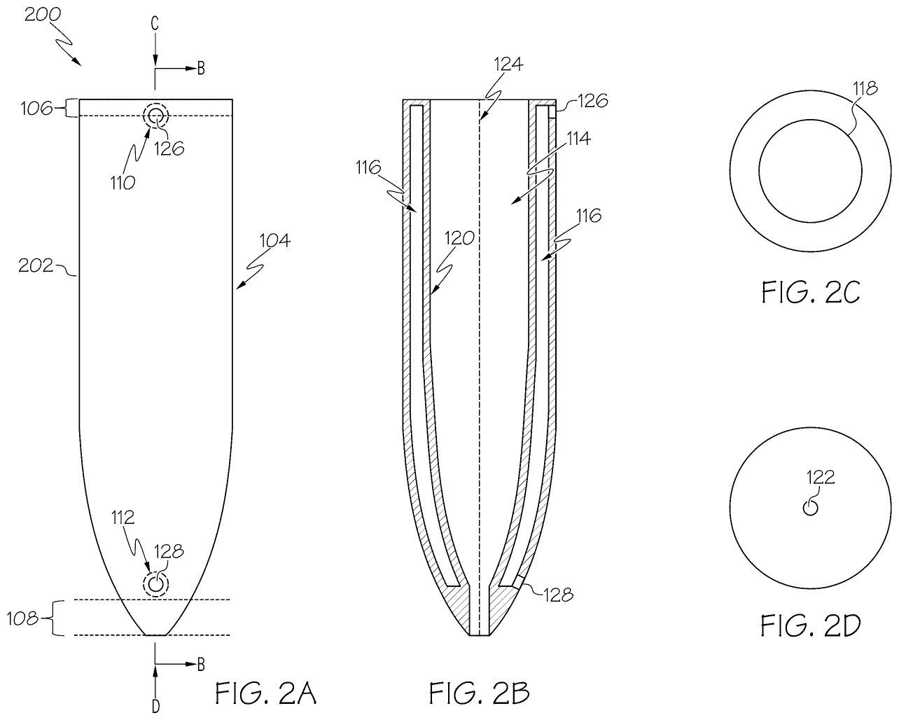

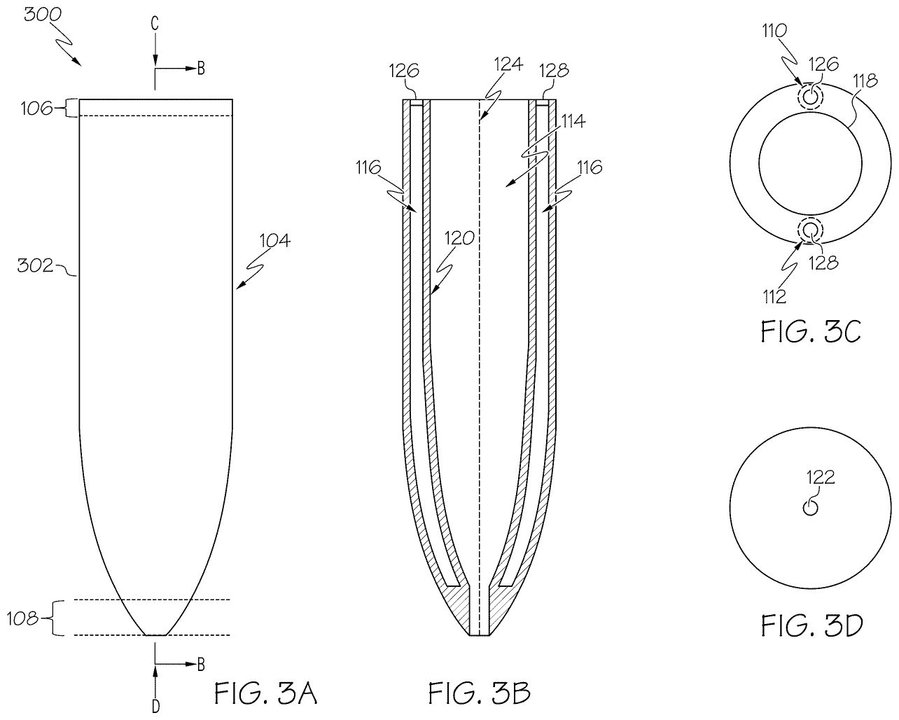

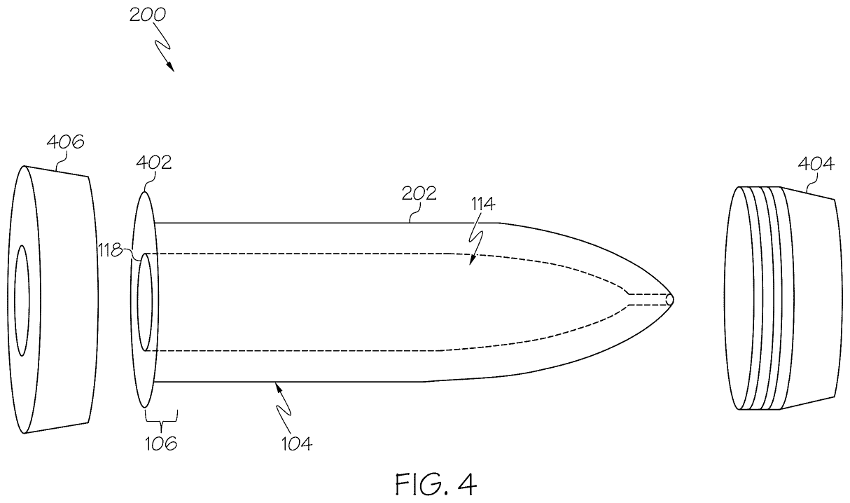

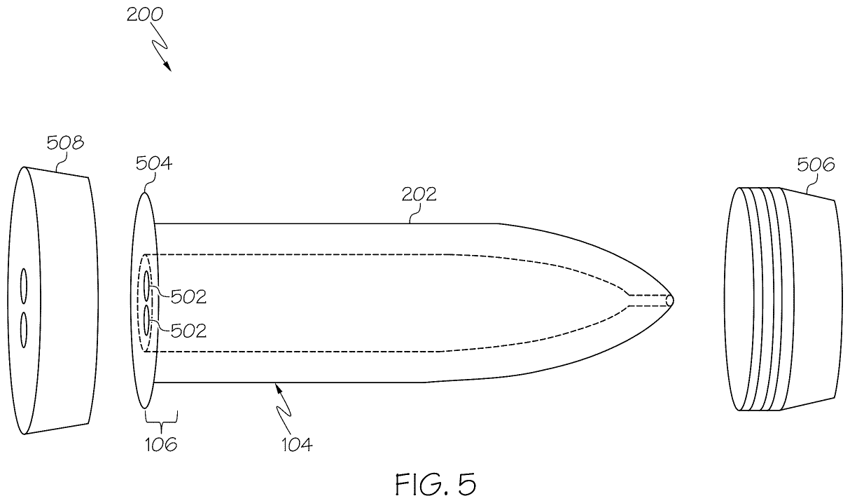

Referring generally to FIGS. 2A-D, 3A-D, 4, 5, 6A-B, 7A-B, 8A-B, 9A-B and 11A-C, by way of examples, the present disclosure is directed to a nozzle 200, 300 for thermoset manufacturing. FIGS. 2A-D, 3A-D, 4 and 5 disclose examples of the nozzle 200, 300 which includes a nozzle body 202, 302 that defines a main chamber 114 and a secondary chamber 116. FIG. 4 discloses another example of the nozzle 200 with a flange 402 and retaining mechanism 404 for coupling to a connector mechanism 406. FIG. 5 discloses yet another example of the nozzle 200 with a flange 504 and retaining mechanism 506 for coupling to a connector mechanism 508. FIGS. 6B, 7B, 8B and 9B disclose various examples of configurations for the secondary chamber 116. In several examples, the nozzle 200, 300 includes a mixing element 1002. FIGS. 11A-C disclose examples of various types of mixing elements 1002.

With reference again to FIGS. 1A-D, 2A-D, 3A-D, 4, 5, 6A-B, 7A-B, 8A-B, 9A-B, 10, 11A-C and 12, in one or more examples, a pipe segment 100 for thermoset manufacturing includes a pipe body 102. The pipe body 102 includes an exterior surface 104, a main inlet portion 106, a main outlet portion 108, a secondary inlet portion 110 and a secondary outlet portion 112. The pipe body 102 defines a main chamber 114 extending from the main inlet portion 106 to the main outlet portion 108. The pipe body 102 further defining a secondary chamber 116 between the exterior surface 104 and the main chamber 114 and extending from the secondary inlet portion 110 to the secondary outlet portion 112.

In another example, the pipe segment 100 includes a nozzle 200, 300 and the pipe body 102 includes a nozzle body 202, 302. In another example of the nozzle 200, 300, the nozzle body 202, 302 is tapered toward the main outlet portion 108.

In yet another example of the nozzle 200, 300, the secondary inlet portion 110 of the nozzle body 202, 302 is disposed proximate to the main inlet portion 106 or along the exterior surface 104 between the main inlet portion 106 and the main outlet portion 108. The secondary outlet portion 112 of the nozzle body 202, 302 is disposed proximate to the main inlet portion 106 or along the exterior surface 104 between the main inlet portion 106 and the main outlet portion 108.

In still another example of the nozzle 200, 300, the main inlet portion 106 of the nozzle 200 includes a main inlet orifice 118 providing access to the main chamber 114. In a further example, the nozzle body 202 defines a retaining flange 402 extending outward from the exterior surface 104 at the main inlet portion 106. In this example, the nozzle 200 also includes a retaining mechanism 404 configured to engage with the retaining flange 402. The retaining mechanism 404 is configured to couple the nozzle 200 and the main inlet orifice 118 to a connector mechanism 406.

In still yet another example of the nozzle 200, 300, the main inlet portion 106 of the nozzle 200 includes at least two main inlet orifices 502 providing access to the main chamber 114. In a further example, the nozzle body 202 defines a retaining flange 504 extending outward from the exterior surface 104 at the main inlet portion 106. In this example, the nozzle 200 also includes a retaining mechanism 506 configured to engage with the retaining flange 504. The retaining mechanism 506 is configured to couple the nozzle 200 and the at least two main inlet orifices 502 to a connector mechanism 508.

In yet another example, the pipe segment 100 is fabricated using additive manufacturing. In a further example, the additive manufacturing includes 3D printing. In still another example of the pipe segment 100, the pipe body 102 includes a metal, titanium, a metal alloy, steel, aluminum, an aluminum alloy, a copper alloy or any other suitable material in any suitable combination. In still yet another example of the pipe segment 100, the pipe body 102 is elongated from the main inlet portion 106 to the main outlet portion 108.

In another example of the pipe segment 100, the pipe body 102 includes an interior surface 120 facing the main chamber 114. In this example, the interior surface 120 includes a nonstick coating. In a further example, the nonstick coating includes a chemical-based coating, a nanoparticle-based coating or any other suitable nonstick coating in any suitable combination. In another further example, the nonstick coating includes a PTFE-based coating or a ceramic-based coating.

In yet another example of the pipe segment 100, the main inlet portion 106 includes a main inlet orifice 118 providing access to the main chamber 114. The main outlet portion 108 includes a main outlet orifice 122 extending from the main chamber 114 to the exterior surface 104 such that the main inlet orifice 118, the main chamber 114 and the main outlet orifice 122 are along a longitudinal axis 124 of the pipe body 102. In a further example, the pipe body 102 defines a bore along the longitudinal axis 124 through the main inlet orifice 118, the main chamber 114 and the main outlet orifice 122.

In still another example of the pipe segment 100, the secondary inlet portion 110 of the pipe body 102 is disposed along the exterior surface 104 between the main inlet portion 106 and the main outlet portion 108. The secondary outlet portion 112 of the pipe body 102 is disposed along the exterior surface 104 between the main inlet portion 106 and the main outlet portion 108.

In still yet another example of the pipe segment 100, the secondary inlet portion 110 includes a secondary inlet orifice 126. The secondary outlet portion 112 includes a secondary outlet orifice 128. In this example, the secondary chamber 116 includes at least one path 602 extending from the secondary inlet orifice 126 to the secondary outlet orifice 128. In a further example, the at least one path 602 includes a spiral path 702 from the secondary inlet orifice 126 to the secondary outlet orifice 128. In another further example, the at least one path 602 includes a plurality of paths 802 substantially circling the main chamber 114. The plurality of paths 802 are interconnected on an inlet end 804 with an inlet routing path 806 from the secondary inlet orifice 126 and interconnected on an outlet end 808 with an outlet routing path 810 to the secondary outlet orifice 128. In yet another further example, the at least one path 602 includes a plurality of paths 902 substantially longitudinal to the main chamber 114. The plurality of paths 902 interconnected on an inlet end 904 with an inlet routing path 906 from the secondary inlet orifice 126 and interconnected on an outlet end 908 with an outlet routing path 910 to the secondary outlet orifice 128. In still another further example, the at least one path 602 includes a plurality of paths 902 angled longitudinally in relation to the main chamber 114. The plurality of paths 902 interconnected on an inlet end 904 with an inlet routing path 906 from the secondary inlet orifice 126 and interconnected on an outlet end 908 with an outlet routing path 910 to the secondary outlet orifice 128.

In another example of the pipe segment 100, a longitudinal axis 124 of the pipe body 102 extends from the main inlet portion 106 to the main outlet portion 108 through the main chamber 114. In a further example, the pipe body 102 includes an interior surface 120 facing the main chamber 114. In this example, the pipe segment 100 also includes a mixing element 1002 disposed within the main chamber 114 such that a central area 1004 of the mixing element 1002 is along the longitudinal axis 124 of the pipe body 102 and a peripheral area 1006 of the mixing element 1002 extends from the central area 1004 toward the interior surface 120. In an even further example, the main chamber 114 of the pipe body 102 and the mixing element 1002 of the pipe segment 100 form a static mixing chamber 1008. In another even further example, the mixing element 1002 includes a spiral mixing element 1102, a helical mixing element 1104, a baffle mixing element, a stair step mixing element 1106, a rotary mixing element or any other suitable mixing element in any suitable combination. In yet another even further example, a cross section of the main chamber 114 along the longitudinal axis 124 includes a circular cross section, an oval cross section, a hexagonal cross section, a square cross section, a rectangular cross section, or any other suitable geometrical cross-section in any suitable combination.

In yet another example of the pipe segment 100, the main inlet portion 106 includes a main inlet orifice 118 providing access to the main chamber 114. In a further example, the pipe body 102 defines a retaining flange 1202 extending outward from the exterior surface 104 at the main inlet portion 106. In this example, the pipe segment 100 also includes a retaining mechanism 1204 configured to engage with the retaining flange 1202. The retaining mechanism 1204 is configured to couple the pipe segment 100 and the main inlet orifice 118 to a connector mechanism 1206.

With reference again to FIGS. 1A-D, 2A-D, 3A-D, 4, 5, 6A-B, 7A-B, 8A-B, 9A-B, 10, 11A-C and 12, in one or more examples, a nozzle 200, 300 for thermoset manufacturing includes a nozzle body 202, 302. The nozzle body 202, 302 includes an exterior surface 104, a main inlet portion 106, a main outlet portion 108, a secondary inlet portion 110 and a secondary outlet portion 112. The nozzle body 202, 302 defining a main chamber 114 extending from the main inlet portion 106 to the main outlet portion 108. The nozzle body 202, 302 further defining a secondary chamber 116 between the exterior surface 104 and the main chamber 114 and extending from the secondary inlet portion 110 to the secondary outlet portion 112. The main inlet portion 106 includes at least two main inlet orifices 502 providing access to the main chamber 114. The main outlet portion 108 includes a main outlet orifice 122 extending from the main chamber 114 to the exterior surface 104 such that the main inlet portion 106, the main chamber 114 and the main outlet orifice 122 are along a longitudinal axis 124 of the nozzle body 202, 302. The secondary inlet portion 110 includes a secondary inlet orifice 126. The secondary outlet portion 112 includes a secondary outlet orifice 128. The secondary chamber 116 includes at least one path 602 extending from the secondary inlet orifice 126 to the secondary outlet orifice 128.

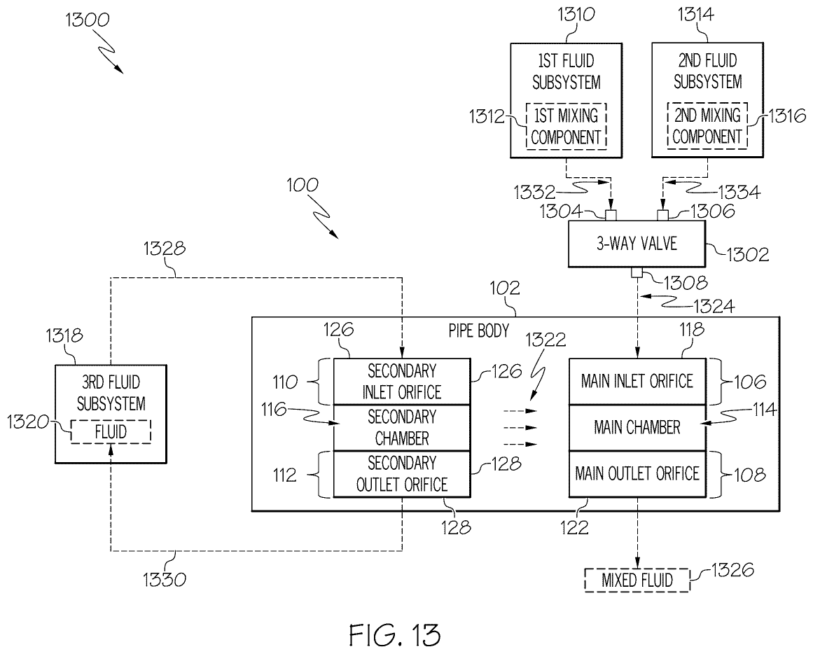

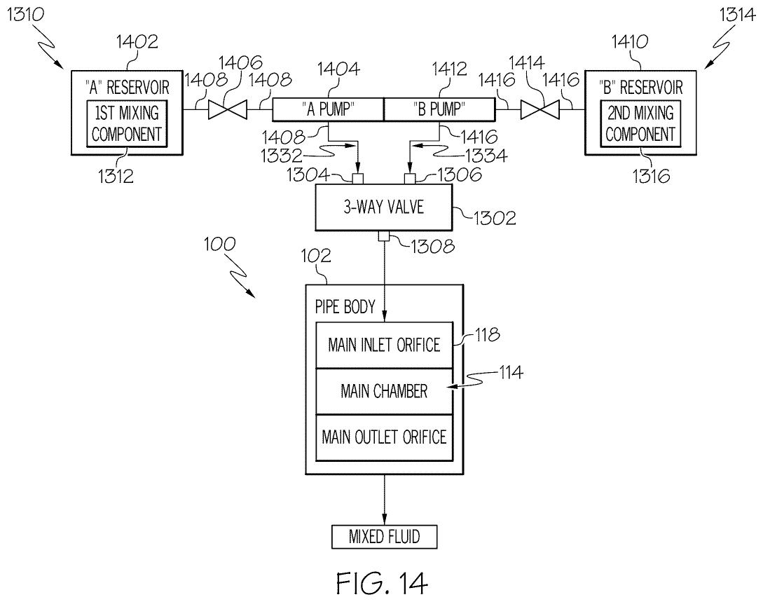

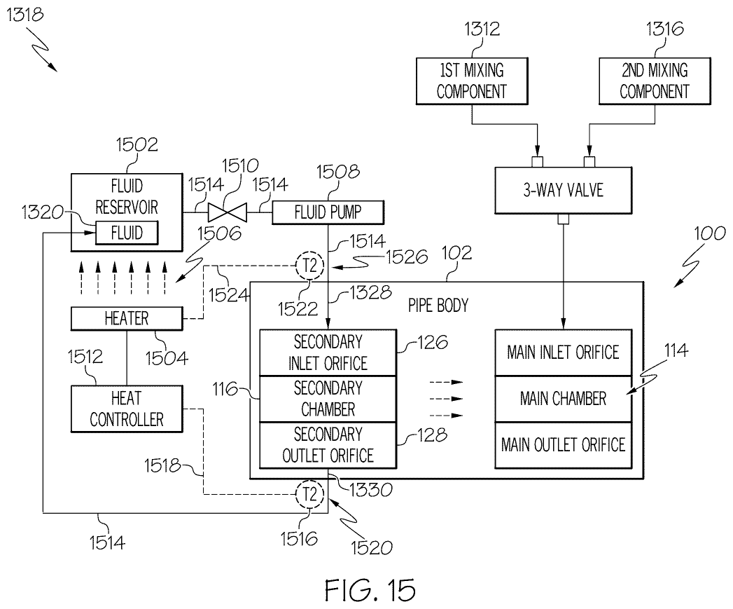

Referring generally to FIGS. 13-15, by way of examples, the present disclosure is directed to a system 1300 for thermoset manufacturing. FIG. 13 discloses an example of the system 1300 which includes a pipe segment 100, a three-way valve 1302, a first fluid subsystem 1310, a second fluid subsystem 1314 and a third fluid subsystem 1318. FIG. 14 discloses an example of the first fluid subsystem 1310 and an example of the second fluid subsystem 1314. FIG. 15 discloses an example of the third fluid subsystem 1318. Although not shown in FIGS. 13-15, a thermoset manufacturing system includes a plurality of mass flow and/or volume flow and/or weighing scales and/or other applicable measuring devices and sensors to determine the ratio of first and second mixing components in the mixed fluid 1326.

With reference again to FIGS. 1A-D and 13, in one or more examples, a system 1300 for thermoset manufacturing includes a pipe segment 100, a three-way valve 1302, a first fluid subsystem 1310, a second fluid subsystem 1314 and a third fluid subsystem 1318. The pipe segment 100 includes a pipe body 102 having an exterior surface 104, a main inlet portion 106, a main outlet portion 108, a secondary inlet portion 110 and a secondary outlet portion 112. The pipe body 102 defining a main chamber 114 extending from the main inlet portion 106 to the main outlet portion 108. The pipe body 102 further defining a secondary chamber 116 between the exterior surface 104 and the main chamber 114 and extending from the secondary inlet portion 110 to the secondary outlet portion 112. The main inlet portion 106 includes a main inlet orifice 118. The main outlet portion 108 includes a main outlet orifice 122. The secondary inlet portion 110 includes a secondary inlet orifice 126. The secondary outlet portion 112 includes a secondary outlet orifice 128. The three-way valve 1302 includes a first inlet connection 1304, a second inlet connection 1306 and an outlet connection 1308. The three-way valve 1302 is in fluid communication with the main chamber 114 of the pipe body 102 via the outlet connection 1308. The first fluid subsystem 1310 in fluid communication with the three-way valve 1302 and the main chamber 114 of the pipe body 102. The first fluid subsystem 1310 is configured to selectively supply a first mixing component 1312 to the main chamber 114 via the first inlet connection 1304, the outlet connection 1308 and the main inlet orifice 118. The second fluid subsystem 1314 in fluid communication with the three-way valve 1302 and the main chamber 114 of the pipe body 102. The second fluid subsystem 1314 is configured to selectively supply a second mixing component 1316 to the main chamber 114 via the second inlet connection 1306, the outlet connection 1308 and the main inlet orifice 118. The third fluid subsystem 1318 in fluid communication with the secondary chamber 116 of the pipe body 102. The third fluid subsystem 1318 is configured to selectively circulate a fluid 1320 through the secondary chamber 116 via the secondary inlet orifice 126 and the secondary outlet orifice 128.

With reference again to FIGS. 1A-D, 2A-D, 4 and 13, in one or more examples of the system 1300, the pipe segment 100 includes a nozzle 200 and the pipe body 102 includes a nozzle body 202. In another example of the nozzle, the nozzle body 202 defines a retaining flange 402 extending outward from the exterior surface 104 at the main inlet portion 106. In this example, the nozzle 200 also includes a retaining mechanism 404 configured to engage with the retaining flange 402. The retaining mechanism 404 is configured to couple the nozzle 200 and the main inlet orifice 118 to the outlet connection 1308 of the three-way valve 1302.

With reference again to FIGS. 1A-D and 13, in one or more examples of the system 1300, the pipe segment 100 is fabricated using additive manufacturing. In a further example, the additive manufacturing includes 3D printing. In another example of the system 1300, the pipe body 102 includes a metal, titanium, a metal alloy, steel, aluminum, an aluminum alloy, a copper alloy or any other suitable material in any suitable combination.

In yet another example of the system 1300, the pipe body 102 includes an interior surface 120 facing the main chamber 114. In this example, the interior surface 120 includes a nonstick coating. In a further example, the nonstick coating includes a chemical-based coating, a nanoparticle-based coating or any suitable nonstick coating in any suitable combination. In another further example, the nonstick coating includes a PTFE-based coating or a ceramic-based coating.

In still yet another example of the system 1300, the pipe body 102 is configured to transfer heat 1322 from the fluid 1320 in the secondary chamber 116 to the first mixing component 1312 and the second mixing component 1316 in the main chamber 114 to maintain a predetermined mixing temperature for at least one of the first mixing component 1312 and the second mixing component 1316. In a further example, the predetermined mixing temperature is at least above an ambient air temperature relative to an external environment of the pipe segment 100.

In another example of the system 1300, the main chamber 114 of the pipe body 102 is configured to couple with the outlet connection 1308 of the three-way valve 1302 to receive an outlet flow 1324 of the first mixing component 1312 and the second mixing component 1316. The main chamber 114 is also configured to mix the first mixing component 1312 and the second mixing component 1316 to form a mixed fluid 1326. Additionally, the main chamber 114 is configured to discharge the mixed fluid 1326 through the main outlet orifice 122 in response to the outlet flow 1324 from the three-way valve 1302.

In yet another example of the system 1300, the main chamber 114 of the pipe body 102 is configured to mix the first mixing component 1312 and the second mixing component 1316 to form a mixed fluid 1326. In a further example, the mixed fluid 1326 includes a thermoset, a thermoset epoxy, a thermoset polyester or any other suitable mixed fluid in any suitable combination.

In still another example of the system 1300, the secondary chamber 116 of the pipe body 102 is configured to couple with the third fluid subsystem 1318 to receive the fluid 1320 via a fluid supply line 1328. The secondary chamber 116 is also configured to direct the fluid 1320 proximate to the main chamber 114 in response to circulation of the fluid (1320) by the third fluid subsystem (1318). Additionally, the secondary chamber 116 is configured to return the fluid 1320 to the third fluid subsystem 1318 via a fluid return line 1330. In a further example, the secondary inlet orifice 126 of the pipe body 102 is configured to couple with the fluid supply line 1328 of the third fluid subsystem 1318 to receive the fluid 1320. In another further example, the secondary outlet orifice 128 of the pipe body 102 is configured to couple with the fluid return line 1330 of the third fluid subsystem 1318 to return the fluid 1320.

With reference again to FIGS. 1A-D, 6B, 7B, 8B, 9B and 13, in one or more examples of the system 1300, the secondary chamber 116 includes at least one path 602 for the fluid 1320. The at least one path extending from the secondary inlet orifice 126 to the secondary outlet orifice 128. In a further example, the at least one path 602 includes a spiral path 702 from the secondary inlet orifice 126 to the secondary outlet orifice 128. In another further example, the at least one path 602 includes a plurality of paths 802 substantially circling the main chamber 114. The plurality of paths 802 interconnected on an inlet end 804 with an inlet routing path 806 from the secondary inlet orifice 126 and interconnected on an outlet end 808 with an outlet routing path 810 to the secondary outlet orifice 128. In yet another further example, the at least one path 602 includes a plurality of paths 902 substantially longitudinal to the main chamber 114. The plurality of paths 902 interconnected on an inlet end 904 with an inlet routing path 906 from the secondary inlet orifice 126 and interconnected on an outlet end 908 with an outlet routing path 910 to the secondary outlet orifice 128. In still another further example, the at least one path 602 includes a plurality of paths 902 angled longitudinally in relation to the main chamber 114. The plurality of paths 902 interconnected on an inlet end 904 with an inlet routing path 906 from the secondary inlet orifice 126 and interconnected on an outlet end 908 with an outlet routing path 910 to the secondary outlet orifice 128.

With reference again to FIG. 13, in one or more examples of the system 1300, the three-way valve 1302 is configured to merge a first flow 1332 of the first mixing component 1312 from the first fluid subsystem 1310 and a second flow 1334 of the second mixing component 1316 from the second fluid subsystem 1314 into an outlet flow 1324 from the outlet connection 1308. In another example of the system 1300, the three-way valve 1302 includes a T-port three-way valve, a Y-port three-way valve, or any suitable three-way valve. In yet another example of the system 1300, the first mixing component 1312 includes a thermoset resin, an epoxy resin, a polyester resin or any other suitable mixing component in any suitable combination. In still yet another example of the system 1300, the second mixing component 1316 includes a thermoset hardener, an epoxy hardener, a polyester hardener, a hardener additive, a catalyst or any other suitable mixing component in any suitable combination. In another example of the system 1300, the fluid 1320 includes a mineral-based oil, a synthetic-based oil, a chemical-based liquid, a coolant liquid, a water-based liquid or any other suitable fluid in any suitable combination.

With reference again to FIGS. 1A-D, 10 and 13, in one or more examples of the system 1300, a longitudinal axis 124 of the pipe body 102 extends from the main inlet portion 106 to the main outlet portion 108 through the main chamber 114. In yet another example of the system 1300, the pipe body 102 includes an interior surface 120 facing the main chamber 114. In this example, the pipe segment 100 also includes a mixing element 1002 disposed within the main chamber 114 such that a central area 1004 of the mixing element 1002 is along the longitudinal axis 124 of the pipe body 102 and a peripheral area 1006 of the mixing element 1002 extends from the central area 1004 toward the interior surface 120. In a further example, the mixing element 1002 is configured to mix the first mixing component 1312 of the first fluid subsystem 1310 and the second mixing component 1316 of the second fluid subsystem 1314 within the main chamber 114 to form a mixed fluid 1326 in response to an outlet flow 1324 of the first mixing component 1312 and the second mixing component 1316 from the outlet connection 1308 of the three-way valve 1302.

In another further example, the main chamber 114 of the pipe body 102 and the mixing element 1002 of the pipe segment 100 form a static mixing chamber 1008. In yet another further example, the mixing element 1002 includes a spiral mixing element 1102, a helical mixing element 1104, a baffle mixing element, a stair step mixing element 1106, a rotary mixing element, or any other suitable mixing element in any suitable combination. In still another further example, a cross section of the main chamber 114 along the longitudinal axis 124 includes a circular cross section, an oval cross section, a hexagonal cross section, a square cross section, a rectangular cross section or any suitable geometrical cross-section in any suitable combination.

With reference again to FIGS. 1A-D, 12 and 13, in one or more examples of the system 1300, the pipe body 102 defines a retaining flange 1202 extending outward from the exterior surface 104 at the main inlet portion 106. In this example, the pipe segment 100 also includes a retaining mechanism 1204 configured to engage with the retaining flange 1202. The retaining mechanism 1204 is configured to couple the pipe segment 100 and the main inlet orifice 118 to the outlet connection 1308 of the three-way valve 1302.

With reference again to FIGS. 1A-D, 13 and 14, in one or more examples of the system 1300, the first fluid subsystem 1310 includes an “A” reservoir 1402, an “A” pump 1404, at least one “A” valve 1406 and a plurality of “A” fluid lines 1408. The “A” reservoir 1402 configured to hold a volume of the first mixing component 1312. The “A” pump 1404 configured to provide a first flow 1332 of the first mixing component 1312 from the “A” reservoir 1402 to the main chamber 114 in the pipe body 102 of the pipe segment 100 via the first inlet connection 1304 of the three-way valve 1302, the outlet connection 1308 and the main inlet orifice 118. The at least one “A” valve 1406 configured to selectively control the first flow 1332 of the first mixing component 1312 to the three-way valve 1302. The plurality of “A” fluid lines 1408 interconnecting the “A” reservoir 1402, the “A” pump 1404, the at least one “A” valve 1406 and the three-way valve 1302. The pipe segment 100 is configured to couple the main inlet orifice 118 with the outlet connection 1308 of the three-way valve 1302 to receive the first mixing component 1312 from the first fluid subsystem 1310.

In still another example of the system 1300, the second fluid subsystem 1314 includes a “B” reservoir 1410, a “B” pump 1412, at least one “B” valve 1414 and a plurality of “B” fluid lines 1416. The “B” reservoir 1410 configured to hold a volume of the second mixing component 1316. The “B” pump 1412 configured to provide a second flow 1334 of the second mixing component 1316 from the “B” reservoir 1410 to the main chamber 114 in the pipe body 102 of the pipe segment 100 via the second inlet connection 1306 of the three-way valve 1302, the outlet connection 1308 and the main inlet orifice 118. The at least one “B” valve 1414 configured to selectively control the second flow 1334 of the second mixing component 1316 to the three-way valve 1302. The plurality of “B” fluid lines 1416 interconnecting the “B” reservoir 1410, the “B” pump 1412, the at least one “B” valve 1414 and the three-way valve 1302. The pipe segment 100 is configured to couple the main inlet orifice 118 with the outlet connection 1308 of the three-way valve 1302 to receive the second mixing component 1316 from the second fluid subsystem 1314.

With reference again to FIGS. 1A-D, 13 and 15, in one or more examples of the system 1300, the third fluid subsystem 1318 includes a fluid reservoir 1502, a heater 1504, a fluid pump 1508, at least one valve 1510, a heater controller 1512 and a plurality of fluid lines 1514. The fluid reservoir 1502 configured to hold a volume of the fluid 1320. The heater 1504 configured to selectively heat 1506 the fluid 1320. The fluid pump 1508 configured to selectively circulate the fluid 1320 from the fluid reservoir 1502 through the secondary chamber 116 in the pipe body 102 of the pipe segment 100 via the secondary inlet orifice 126 and the secondary outlet orifice 128. The at least one valve 1510 configured to selectively control circulation of the fluid 1320. The heater controller 1512 configured to selectively control the heater 1504. The plurality of fluid lines 1514 interconnecting the fluid reservoir 1502, the fluid pump 1508, the at least one valve 1510, the secondary inlet orifice 126 and the secondary outlet orifice 128. The secondary inlet orifice 126 is configured to couple with a fluid supply line 1328 of the plurality of fluid lines 1514 to receive the fluid 1320 from the third fluid subsystem 1318. The secondary outlet orifice 128 is configured to couple with a fluid return line 1330 of the plurality of fluid lines 1514 to return the fluid 1320 to the third fluid subsystem 1318.

In still yet another example of the system 1300, the third fluid subsystem 1318 also includes a first temperature sensor 1516 disposed in relation to the secondary chamber 116 and the fluid return line 1330. The first temperature sensor 1516 configured to provide a first temperature signal 1518 to the heater controller 1512 indicative of a temperature relating to a first fluid flow 1520 from the secondary chamber 116 to the third fluid subsystem 1318 in the fluid return line 1330.

In a further example, the heater controller 1512 is configured to selectively activate the heater 1504 based at least in part on the first temperature signal 1518 indicating the first fluid flow 1520 in the fluid return line 1330 is below a first predetermined temperature threshold. In an even further example, the first predetermined temperature threshold relates to a minimum target temperature for mixing the first mixing component 1312 and the second mixing component 1316 in the main chamber 114.

In another further example, the heater controller 1512 is configured to selectively deactivate the heater 1504 based at least in part on the first temperature signal 1518 indicating the first fluid flow 1520 in the fluid return line 1330 is above a second predetermined temperature threshold. In an even further example, the second predetermined temperature threshold relates to a maximum target temperature for mixing the first mixing component 1312 and the second mixing component 1316 in the main chamber 114. In yet another further example, the third fluid subsystem 1318 also includes a second temperature sensor 1522 disposed in relation to the secondary chamber 116 and a fluid supply line 1328. The second temperature sensor 1522 configured to provide a second temperature signal 1524 to the heater controller 1512 indicative of a temperature relating to a second fluid flow 1526 to the secondary chamber 116 from the third fluid subsystem 1318 in the fluid supply line 1328.

In an even further example, the heater controller 1512 is configured to selectively activate the heater 1504 based at least in part on the first temperature signal 1518 indicating the first fluid flow 1520 in the fluid return line 1330 is below a first predetermined temperature threshold. In another even further example, the first predetermined temperature threshold relates to a minimum target temperature for mixing the first mixing component 1312 and the second mixing component 1316 in the main chamber 114.

In yet another even further example, the heater controller 1512 is configured to selectively deactivate the heater 1504 based at least in part on the second temperature signal 1524 indicating the second fluid flow 1526 in the fluid supply line 1328 is above a second predetermined temperature threshold. In this example, the second predetermined temperature threshold may relate to a maximum target temperature for mixing the first mixing component 1312 and the second mixing component 1316 in the main chamber 114.

In another example of the system 1300, the third fluid subsystem 1318 also includes a plurality of temperature sensors (e.g., 1516, 1522) disposed in relation to at least one of the fluid supply line 1328, the secondary chamber 116 and the fluid return line 1330 to provide corresponding temperature signals (e.g., 1518, 1524) to the heater controller 1512 indicative of temperatures relating to fluid flows (e.g., 1520, 1526) within the third fluid subsystem 1318.

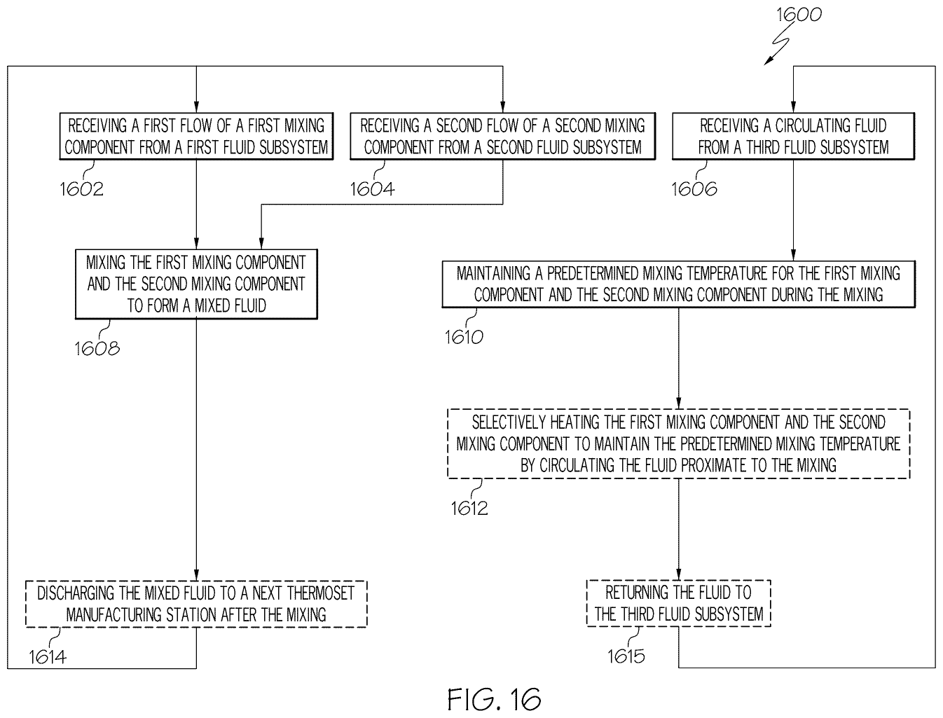

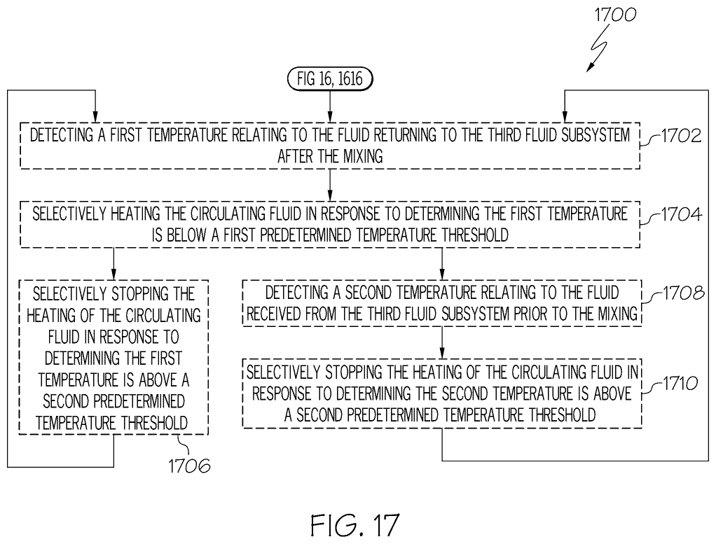

Referring generally to FIGS. 16 and 17, by way of examples, the present disclosure is directed to methods 1600, 1700 for thermoset manufacturing. FIG. 16 discloses an example of the method 1600 for thermoset manufacturing. FIG. 17, in combination with FIG. 16 discloses the method 1700 for thermoset manufacturing.

With reference again to FIGS. 13 and 16, in one or more examples, a method 1600 for thermoset manufacturing begins at 1602 where a first flow 1332 of a first mixing component 1312 is received from a first fluid subsystem 1310. At 1604, a second flow 1334 of a second mixing component 1316 is received from a second fluid subsystem 1314. At 1606, a fluid 1320 circulated by a third fluid subsystem 1318 is received. At 1608, the first mixing component 1312 and the second mixing component 1316 are mixed to form a mixed fluid 1326. At 1610, a predetermined mixing temperature is maintained for the first mixing component 1312 and the second mixing component 1316 during the mixing 1608.

In another example, the method 1600 also includes selectively heating 1612 the first mixing component 1312 and the second mixing component 1316 during the mixing 1608 to maintain the predetermined mixing temperature by circulating the fluid 1320 proximate to the mixing 1608.

In yet another example, the method 1600 also includes discharging 1614 the mixed fluid 1326 to a next thermoset manufacturing station after the mixing 1608. In a further example, the discharging 1614 includes injecting the mixed fluid 1326 into a composite part mold to support injection molding. In another further example, the discharging 1614 includes infusing the mixed fluid 1326 into a composite part tool to support resin infusion.

In still another example, the method 1600 also includes returning 1616 the fluid 1320 to the third fluid subsystem 1318.

With reference again to FIGS. 13, 16 and 17, in one or more examples, a method 1700 for thermoset manufacturing continues from 1616 of FIG. 16 to 1702 where a first temperature is detected relating to the fluid 1320 returning to the third fluid subsystem 1318 after the mixing 1608. At 1704, the fluid 1320 is selectively heated in response to determining the first temperature is below a first predetermined temperature threshold.

In a further example, the first predetermined temperature threshold relates to a minimum target temperature for mixing the first mixing component 1312 and the second mixing component 1316.

In another further example, the method 1700 also includes selectively stopping 1706 the heating 1704 of the fluid 1320 in response to determining the first temperature is above a second predetermined temperature threshold. In this example, the second predetermined temperature threshold may relate to a maximum target temperature for mixing the first mixing component 1312 and the second mixing component 1316.

In yet another further example, the method 1700 also includes detecting 1708 a second temperature relating to the fluid 1320 received from the third fluid subsystem 1318 prior to the mixing 1608. At 1710, the heating 1704 of the fluid 1320 is selectively stopped in response to determining the second temperature is above a second predetermined temperature threshold. In this example, the second predetermined temperature threshold may relate to a maximum target temperature for mixing the first mixing component 1312 and the second mixing component 1316. Examples of pipe segments 100, nozzles 200, 300, systems 1300 and methods 1600, 1700 for thermoset manufacturing may be related to or used in the context of aircraft manufacturing. Although an aircraft example is described, the examples and principles disclosed herein may be applied to other products in the aerospace industry and other industries, such as the automotive industry, the space industry, the construction industry and other design and manufacturing industries. Accordingly, in addition to aircraft, the examples and principles disclosed herein may apply to the use of thermoset products in the manufacture of various types of vehicles and in the construction of various types of buildings.

The preceding detailed description refers to the accompanying drawings, which illustrate specific examples described by the present disclosure. Other examples having different structures and operations do not depart from the scope of the present disclosure. Like reference numerals may refer to the same feature, element, or component in the different drawings. Throughout the present disclosure, any one of a plurality of items may be referred to individually as the item and a plurality of items may be referred to collectively as the items and may be referred to with like reference numerals. Moreover, as used herein, a feature, element, component, or step preceded with the word “a” or “an” should be understood as not excluding a plurality of features, elements, components, or steps, unless such exclusion is explicitly recited.

Illustrative, non-exhaustive examples, which may be, but are not necessarily, claimed, of the subject matter according to the present disclosure are provided above. Reference herein to “example” means that one or more feature, structure, element, component, characteristic, and/or operational step described in connection with the example is included in at least one aspect, embodiment, and/or implementation of the subject matter according to the present disclosure. Thus, the phrases “an example,” “another example,” “one or more examples,” and similar language throughout the present disclosure may, but do not necessarily, refer to the same example. Further, the subject matter characterizing any one example may, but does not necessarily, include the subject matter characterizing any other example. Moreover, the subject matter characterizing any one example may be, but is not necessarily, combined with the subject matter characterizing any other example.

As used herein, a system, apparatus, device, structure, article, element, component, or hardware “configured to” perform a specified function is indeed capable of performing the specified function without any alteration, rather than merely having potential to perform the specified function after further modification. In other words, the system, apparatus, device, structure, article, element, component, or hardware “configured to” perform a specified function is specifically selected, created, implemented, utilized, programmed, and/or designed for the purpose of performing the specified function. As used herein, “configured to” denotes existing characteristics of a system, apparatus, structure, article, element, component, or hardware that enable the system, apparatus, structure, article, element, component, or hardware to perform the specified function without further modification. For purposes of this disclosure, a system, apparatus, device, structure, article, element, component, or hardware described as being “configured to” perform a particular function may additionally or alternatively be described as being “adapted to” and/or as being “operative to” perform that function.

Unless otherwise indicated, the terms “first,” “second,” “third,” etc. are used herein merely as labels, and are not intended to impose ordinal, positional, or hierarchical requirements on the items to which these terms refer. Moreover, reference to, e.g., a “second” item does not require or preclude the existence of, e.g., a “first” or lower-numbered item, and/or, e.g., a “third” or higher-numbered item.

As used herein, the phrase “at least one of,” when used with a list of items, means different combinations of one or more of the listed items may be used and only one of each item in the list may be needed. For example, “at least one of item A, item B, and item C” may include, without limitation, item A or item A and item B. This example also may include item A, item B, and item C, or item B and item C. In other examples, “at least one of” may be, for example, without limitation, two of item A, one of item B, and ten of item C; four of item B and seven of item C; and other suitable combinations. As used herein, the term “and/or” and the “/” symbol includes any and all combinations of one or more of the associated listed items.

As used herein, the terms “coupled,” “coupling,” and similar terms refer to two or more elements that are joined, linked, fastened, attached, connected, put in communication, or otherwise associated (e.g., mechanically, electrically, fluidly, optically, electromagnetically) with one another. In various examples, the elements may be associated directly or indirectly. As an example, element A may be directly associated with element B. As another example, element A may be indirectly associated with element B, for example, via another element C. It will be understood that not all associations among the various disclosed elements are necessarily represented. Accordingly, couplings other than those depicted in the figures may also exist.

As used herein, the term “approximately” refers to or represents a condition that is close to, but not exactly, the stated condition that still performs the desired function or achieves the desired result. As an example, the term “approximately” refers to a condition that is within an acceptable predetermined tolerance or accuracy, such as to a condition that is within 10% of the stated condition. However, the term “approximately” does not exclude a condition that is exactly the stated condition. As used herein, the term “substantially” refers to a condition that is essentially the stated condition that performs the desired function or achieves the desired result.

FIGS. 1A-D, 2A-D, 3A-D, 4, 5, 6A-B, 7A-B, 8A-B, 9A-B, 10, 11A-C and 12-15, referred to above, may represent functional elements, features, or components thereof and do not necessarily imply any particular structure. Accordingly, modifications, additions and/or omissions may be made to the illustrated structure. Additionally, those skilled in the art will appreciate that not all elements, features, and/or components described and illustrated in FIGS. 1A-D, 2A-D, 3A-D, 4, 5, 6A-B, 7A-B, 8A-B, 9A-B, 10, 11A-C and 12-15, referred to above, need be included in every example and not all elements, features, and/or components described herein are necessarily depicted in each illustrative example. Accordingly, some of the elements, features, and/or components described and illustrated in FIGS. 1A-D, 2A-D, 3A-D, 4, 5, 6A-B, 7A-B, 8A-B, 9A-B, 10, 11A-C and 12-15 may be combined in various ways without the need to include other features described and illustrated in FIGS. 1A-D, 2A-D, 3A-D, 4, 5, 6A-B, 7A-B, 8A-B, 9A-B, 10, 11A-C and 12-15, other drawing figures, and/or the accompanying disclosure, even though such combination or combinations are not explicitly illustrated herein. Similarly, additional features not limited to the examples presented, may be combined with some or all the features shown and described herein. Unless otherwise explicitly stated, the schematic illustrations of the examples depicted in FIGS. 1A-D, 2A-D, 3A-D, 4, 5, 6A-B, 7A-B, 8A-B, 9A-B, 10, 11A-C and 12-15, referred to above, are not meant to imply structural limitations with respect to the illustrative example. Rather, although one illustrative structure is indicated, it is to be understood that the structure may be modified when appropriate. Accordingly, modifications, additions and/or omissions may be made to the illustrated structure. Furthermore, elements, features, and/or components that serve a similar, or at least substantially similar, purpose are labeled with like numbers in each of FIGS. 1A-D, 2A-D, 3A-D, 4, 5, 6A-B, 7A-B, 8A-B, 9A-B, 10, 11A-C and 12-15, and such elements, features, and/or components may not be discussed in detail herein with reference to each of FIGS. 1A-D, 2A-D, 3A-D, 4, 5, 6A-B, 7A-B, 8A-B, 9A-B, 10, 11A-C and 12-15. Similarly, all elements, features, and/or components may not be labeled in each of FIGS. 1A-D, 2A-D, 3A-D, 4, 5, 6A-B, 7A-B, 8A-B, 9A-B, 10, 11A-C and 12-15, but reference numerals associated therewith may be utilized herein for consistency.

In FIGS. 16 and 17, referred to above, the blocks may represent operations, steps, and/or portions thereof, and lines connecting the various blocks do not imply any particular order or dependency of the operations or portions thereof. It will be understood that not all dependencies among the various disclosed operations are necessarily represented. FIGS. 16 and 17 and the accompanying disclosure describing the operations of the disclosed methods set forth herein should not be interpreted as necessarily determining a sequence in which the operations are to be performed. Rather, although one illustrative order is indicated, it is to be understood that the sequence of the operations may be modified when appropriate. Accordingly, modifications, additions and/or omissions may be made to the operations illustrated and certain operations may be performed in a different order or simultaneously. Additionally, those skilled in the art will appreciate that not all operations described need be performed.

Further, references throughout the present specification to features, advantages, or similar language used herein do not imply that all the features and advantages that may be realized with the examples disclosed herein should be, or are in, any single example. Rather, language referring to the features and advantages is understood to mean that a specific feature, advantage, or characteristic described in connection with an example is included in at least one example. Thus, discussion of features, advantages, and similar language used throughout the present disclosure may, but does not necessarily, refer to the same example.

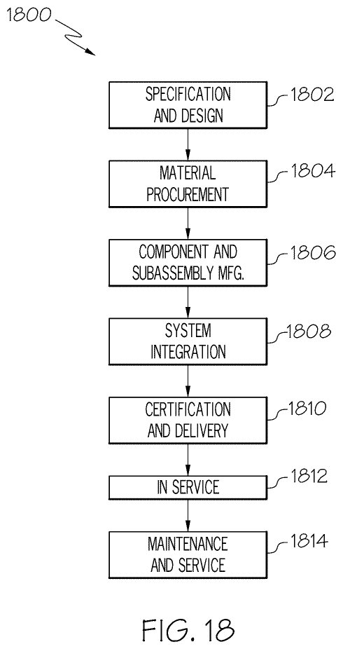

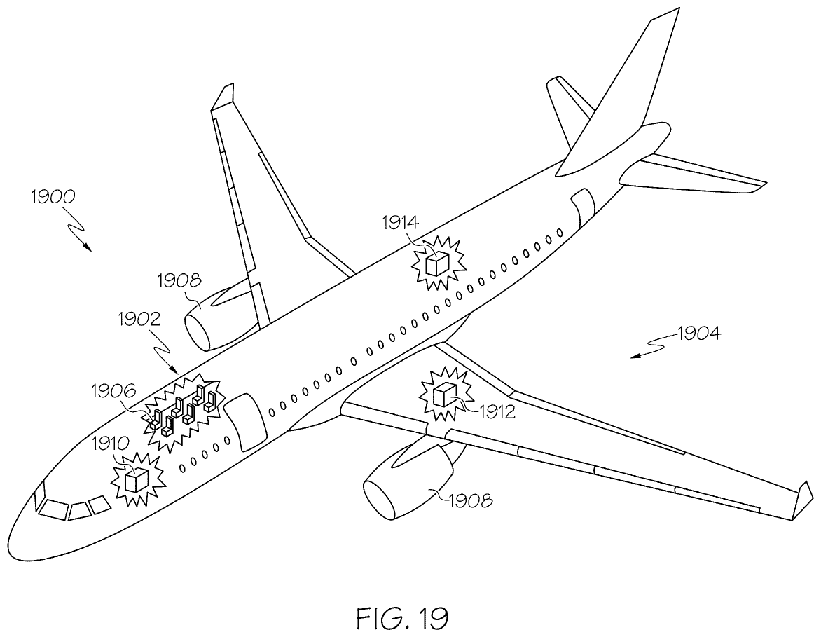

Examples of the subject matter disclosed herein may be described in the context of aircraft manufacturing and service method 1800 as shown in FIG. 18 and aircraft 1900 as shown in FIG. 19. In one or more examples, the disclosed methods and systems for associating test data for a part under test with an end item coordinate system may be used in aircraft manufacturing. During pre-production, the service method 1800 may include specification and design (block 1802) of aircraft 1900 and material procurement (block 1804). During production, component and subassembly manufacturing (block 1806) and system integration (block 1808) of aircraft 1900 may take place. Thereafter, aircraft 1900 may go through certification and delivery (block 1810) to be placed in service (block 1812). While in service, aircraft 1900 may be scheduled for routine maintenance and service (block 1814). Routine maintenance and service may include modification, reconfiguration, refurbishment, etc. of one or more systems of aircraft 1900.

Each of the processes of the service method 1800 may be performed or carried out by a system integrator, a third party, and/or an operator (e.g., a customer). For the purposes of this description, a system integrator may include, without limitation, any number of aircraft manufacturers and major-system subcontractors; a third party may include, without limitation, any number of vendors, subcontractors, and suppliers; and an operator may be an airline, leasing company, military entity, service organization, and so on.

As shown in FIG. 19, aircraft 1900 produced by the service method 1800 may include airframe 1902 with a plurality of high-level systems 1904 and interior 1906. Examples of high-level systems 1904 include one or more of propulsion system 1908, electrical system 1910, hydraulic system 1912, and environmental system 1914. Any number of other systems may be included. Although an aerospace example is shown, the principles disclosed herein may be applied to other industries, such as the automotive industry. Accordingly, in addition to aircraft 1900, the principles disclosed herein may apply to other vehicles, e.g., land vehicles, marine vehicles, space vehicles, etc.

The disclosed systems and methods for associating test data for a part under test with an end item coordinate system may be employed during any one or more of the stages of the manufacturing and service method 1800. For example, components or subassemblies corresponding to component and subassembly manufacturing (block 1806) may be fabricated or manufactured in a manner similar to components or subassemblies produced while aircraft 1900 is in service (block 1812). Also, one or more examples of the system(s), method(s), or combination thereof may be utilized during production stages (block 1806 and block 1808), for example, by substantially expediting assembly of or reducing the cost of aircraft 1900. Similarly, one or more examples of the system or method realizations, or a combination thereof, may be utilized, for example and without limitation, while aircraft 1900 is in service (block 1812) and/or during maintenance and service (block 1814).

The described features, advantages, and characteristics of one example may be combined in any suitable manner in one or more other examples. One skilled in the relevant art will recognize that the examples described herein may be practiced without one or more of the specific features or advantages of a particular example. In other instances, additional features and advantages may be recognized in certain examples that may not be present in all examples. Furthermore, although various examples of the compliant pipe segment 100, nozzle 200, 300, system 1300, and methods 1600, 1700 for thermoset manufacturing have been shown and described, modifications may occur to those skilled in the art upon reading the specification. The present application includes such modifications and is limited only by the scope of the claims.

1. A pipe segment for thermoset manufacturing, comprising:
a pipe body comprising an exterior surface, a main inlet portion, a main outlet portion, a secondary inlet portion and a secondary outlet portion, the pipe body defining a main chamber extending from the main inlet portion to the main outlet portion, the pipe body further defining a secondary chamber between the exterior surface and the main chamber and extending from the secondary inlet portion to the secondary outlet portion.

2. The pipe segment of claim 1, wherein the pipe segment comprises a nozzle and the pipe body comprises a nozzle body.

3. (canceled)

4. The pipe segment of claim 2, wherein the secondary inlet portion of the nozzle body is disposed proximate to the main inlet portion or along the exterior surface between the main inlet portion and the main outlet portion and the secondary outlet portion of the nozzle body is disposed proximate to the main inlet portion or along the exterior surface between the main inlet portion and the main outlet portion.

5. The pipe segment of claim 2, wherein the main inlet portion of the nozzle comprises a main inlet orifice providing access to the main chamber.

6. (canceled)

7. The pipe segment of claim 2, wherein the main inlet portion of the nozzle comprises at least two main inlet orifices providing access to the main chamber.

8. The pipe segment of claim 7, wherein the nozzle body defines a retaining flange extending outward from the exterior surface at the main inlet portion, the nozzle further comprising:
a retaining mechanism configured to engage with the retaining flange, wherein the retaining mechanism is configured to couple the nozzle and the at least two main inlet orifices to a connector mechanism.

9-11. (canceled)

12. The pipe segment of claim 1, wherein the pipe body is elongated from the main inlet portion to the main outlet portion.

13. The pipe segment of claim 1, wherein the pipe body comprises an interior surface facing the main chamber, the interior surface comprising a nonstick coating.

14-15. (canceled)

16. The pipe segment of claim 1, wherein the main inlet portion comprises a main inlet orifice providing access to the main chamber and the main outlet portion comprises a main outlet orifice extending from the main chamber to the exterior surface such that the main inlet orifice, the main chamber and the main outlet orifice are along a longitudinal axis of the pipe body.

17. The pipe segment of claim 16, wherein the pipe body defines a bore along the longitudinal axis through the main inlet orifice, the main chamber and the main outlet orifice.

18. The pipe segment of claim 1, wherein the secondary inlet portion of the pipe body is disposed along the exterior surface between the main inlet portion and the main outlet portion and the secondary outlet portion of the pipe body is disposed along the exterior surface between the main inlet portion and the main outlet portion.

19. The pipe segment of claim 1, wherein the secondary inlet portion comprises a secondary inlet orifice, the secondary outlet portion comprises a secondary outlet orifice and the secondary chamber comprises at least one path extending from the secondary inlet orifice to the secondary outlet orifice.

20. The pipe segment of claim 19, wherein the at least one path comprises a spiral path from the secondary inlet orifice to the secondary outlet orifice.

21. The pipe segment of claim 19, wherein the at least one path comprises a plurality of paths substantially circling the main chamber, the plurality of paths interconnected on an inlet end with an inlet routing path from the secondary inlet orifice and interconnected on an outlet end with an outlet routing path to the secondary outlet orifice.

22. The pipe segment of claim 19, wherein the at least one path comprises a plurality of paths substantially longitudinal to the main chamber, the plurality of paths interconnected on an inlet end with an inlet routing path from the secondary inlet orifice and interconnected on an outlet end with an outlet routing path to the secondary outlet orifice.

23. The pipe segment of claim 19, wherein the at least one path comprises a plurality of paths angled longitudinally in relation to the main chamber, the plurality of paths interconnected on an inlet end with an inlet routing path from the secondary inlet orifice and interconnected on an outlet end with an outlet routing path to the secondary outlet orifice.

24. The pipe segment of claim 1, wherein a longitudinal axis of the pipe body extends from the main inlet portion to the main outlet portion through the main chamber.

25. The pipe segment of claim 24, wherein the pipe body comprises an interior surface facing the main chamber, the pipe segment further comprising:
a mixing element disposed within the main chamber such that a central area of the mixing element is along the longitudinal axis of the pipe body and a peripheral area of the mixing element extends from the central area toward the interior surface.

26. (canceled)

27. The pipe segment of claim 25, wherein the mixing element comprises at least one of a spiral mixing element, a helical mixing element, a baffle mixing element, a stair step mixing element and a rotary mixing element.

28. The pipe segment of claim 25, wherein a cross section of the main chamber along the longitudinal axis comprises at least one of a circular cross section, an oval cross section, a hexagonal cross section, a square cross section and a rectangular cross section.

29. The pipe segment of claim 1, wherein the main inlet portion comprises a main inlet orifice providing access to the main chamber.

30. The pipe segment of claim 29, wherein the pipe body defines a retaining flange extending outward from the exterior surface at the main inlet portion, the pipe segment further comprising:
a retaining mechanism configured to engage with the retaining flange, wherein the retaining mechanism is configured to couple the pipe segment and the main inlet orifice to a connector mechanism.

31. A nozzle for thermoset manufacturing, comprising:
a nozzle body comprising an exterior surface, at least two main inlet orifices, a main outlet orifice, a secondary inlet orifice and a secondary outlet orifice, the nozzle body defining a main chamber extending from the at least two main inlet orifices to the main outlet orifice, the nozzle body further defining a secondary chamber between the exterior surface and the main chamber and extending from the secondary inlet orifice to the secondary outlet orifice.

32-34. (canceled)

35. A system for thermoset manufacturing, comprising:
a pipe segment comprising a pipe body having an exterior surface, a main inlet portion, a main outlet portion, a secondary inlet portion and a secondary outlet portion, the pipe body defining a main chamber extending from the main inlet portion to the main outlet portion, the pipe body further defining a secondary chamber between the exterior surface and the main chamber and extending from the secondary inlet portion to the secondary outlet portion, wherein the main inlet portion comprises a main inlet orifice, wherein the main outlet portion comprises a main outlet orifice, wherein the secondary inlet portion comprises a secondary inlet orifice, wherein the secondary outlet portion comprises a secondary outlet orifice;
a three-way valve comprising a first inlet connection, a second inlet connection and an outlet connection, wherein the three-way valve is in fluid communication with the main chamber of the pipe body via the outlet connection;
a first fluid subsystem in fluid communication with the three-way valve and the main chamber of the pipe body, wherein the first fluid subsystem is configured to selectively supply a first mixing component to the main chamber via the first inlet connection, the outlet connection and the main inlet orifice;
a second fluid subsystem in fluid communication with the three-way valve and the main chamber of the pipe body, wherein the second fluid subsystem is configured to selectively supply a second mixing component to the main chamber via the second inlet connection, the outlet connection and the main inlet orifice; and
a third fluid subsystem in fluid communication with the secondary chamber of the pipe body, wherein the third fluid subsystem is configured to selectively circulate a fluid through the secondary chamber via the secondary inlet orifice and the secondary outlet orifice.

36-82. (canceled)

83. A method for thermoset manufacturing, comprising:
receiving a first flow of a first mixing component from a first fluid subsystem;
receiving a second flow of a second mixing component from a second fluid subsystem;
receiving a fluid circulated by a third fluid subsystem;
mixing the first mixing component and the second mixing component to form a mixed fluid; and
maintaining a predetermined mixing temperature for the first mixing component and the second mixing component during the mixing.

84-94. (canceled)
